(19) United States
(12) Patent Application Publication
(10) Pub. No.: US 2026/0093061 A1
(43) Pub. Date: Apr. 2, 2026

(54) OPTICAL LOW-PASS FILTER, IMAGING APPARATUS, AND IMAGING SYSTEM

(71) Applicant: FUJIFILM Corporation, Tokyo (JP)

(72) Inventors: Tomoyuki KAWAI, Saitama-shi (JP); Yoshinori FURUTA, Saitama-shi (JP); Kazuya Oda, Saitama-shi (JP); Seiji Tanaka, Saitama-shi (JP)

(73) Assignee: FUJIFILM Corporation, Tokyo (JP)

(21) Appl. No.: 19/339,343

(22) Filed: Sep. 25, 2025

(30) Foreign Application Priority Data
Sep. 27, 2024 (JP) 2024-169323

(51) Int. Cl. G02B 5/20; H04N 23/667; H04N 25/78

(52) U.S. Cl. CPC G02B 5/201; H04N 23/667; H04N 25/78

(57) ABSTRACT

An imaging element performs averaging readout of signals of a plurality of pixels in a first direction and thinning-out readout. When an arrangement pitch of the pixels is p, a distance between spatial positions of the signals in the first direction is L, the number of pixels in which the signals are not read out between a pixel that is a generation source of a signal at a first spatial position and a pixel that is a generation source of a signal at an adjacent second spatial position is j, a difference between the number of pixels is k, a sum of j and k is n, and at least one of the averaging readout or the thinning-out readout is performed, an optical filter separates a point image into (n+1) points with p as a separation width and into two points with L as a separation width.

### CROSS-REFERENCE TO RELATED APPLICATIONS

This application is based upon and claims the benefit of priority from prior Japanese patent application No. 2024-169323, filed on Sep. 27, 2024, the entire contents of which are incorporated herein by reference.

### BACKGROUND OF THE INVENTION

### 1. Field of the Invention

The technology of the present disclosure relates to an optical filter, an imaging apparatus, and an imaging system. The present disclosure relates to an optical low-pass filter, but is not limited to.

### 2. Description of the Related Art

JP2002-369083A discloses an imaging apparatus including a drive control circuit that performs drive control of an imaging element that images a subject through an imaging optical system to switch between a first scanning form that is a scanning performed using a plurality of pixels disposed on an imaging surface of the imaging element and in which thinning-out scanning is not included and a second scanning form in which a part of the plurality of pixels is thinned out and scanned, in which the imaging optical system is configured to include a plurality of optical low-pass filters that limit a spatial frequency characteristic of an incident luminous flux, each of the plurality of low-pass filters consists of a different spatial frequency characteristic, and the plurality of low-pass filters are used by switching between the first scanning form and the second scanning form.

JP2013-172346A discloses an imaging apparatus comprising a first optical filter that is fixed to reduce a spatial frequency of incident subject luminous flux and emit the subject luminous flux, a second optical filter that is inserted into and removed from the subject luminous flux and changes the spatial frequency of the incident subject luminous flux to emit the subject luminous flux, and an imaging element that receives the subject luminous flux transmitted through the first optical filter without being transmitted through the second optical filter or the subject luminous flux transmitted through the first optical filter and the second optical filter and outputs an image signal.

JP2013-190603A describes an optical low-pass filter device comprising first and second birefringent optical members, and a polarization state variable unit that is disposed between the first birefringent optical member and the second birefringent optical member and is capable of changing a polarization state of incident light.

### SUMMARY OF THE INVENTION

At least the following matters are described in the present specification.

(1)

An optical filter disposed on a subject side from an imaging element,
in which the imaging element is capable of performing at least one of averaging readout of averaging and reading out signals of a plurality of pixels arranged in a first direction or thinning-out readout of reading out the signals from a part of the plurality of pixels arranged in the first direction and not reading out the signals from parts other than the part of the plurality of pixels,
an arrangement pitch of the pixels in the first direction is denoted by p,
a distance between spatial positions of the signals in the first direction read out from the pixels arranged in the first direction is denoted by L,
the number of pixels in which the signals are not read out between a pixel that is a generation source of a signal at a first spatial position and a pixel that is a generation source of a signal at a second spatial position adjacent to the first spatial position is denoted by j,
an absolute value of a difference between the number of pixels that are the generation sources of the signals at the first spatial position and the number of pixels that are the generation sources of the signals at the second spatial position is denoted by k,
a sum of j and k is denoted by n, and
in a case where at least one of the averaging readout or the thinning-out readout is performed, the optical filter has a characteristic in which a point image is separated into (n+1) points with p as a separation width and is separated into two points with L as a separation width, or a characteristic in which a numerical value greater than 0.7 and smaller than 1 is denoted by α, and the point image is separated into (n+1) points with α×p as a separation width and is separated into two points with α×L as a separation width.
   (2)

The optical filter according to (1),
in which, in a case where the averaging readout and the thinning-out readout are not performed, the optical filter has a characteristic in which the point image is separated into two points with L as the separation width.
   (3)

The optical filter according to (1) or (2),
in which, in a case where the thinning-out readout is performed among the averaging readout and the thinning-out readout, k=0 is satisfied.
   (4)

The optical filter according to any one of (1) to (3),
in which A is set to a natural number of 2 or more,
the averaging readout includes a first averaging readout of reading out a signal at the first spatial position by averaging the signals in A pixels and reading out a signal at the second spatial position from a single pixel,
in the thinning-out readout, at least the signals are not read out from the pixels disposed between the A pixels, and
in a case where both the first averaging readout and the thinning-out readout are performed, k is 1 or more.
   (5)

The optical filter according to any one of (1) to (4),
in which A is set to a natural number of 2 or more and B is set to a value larger than A,
the averaging readout includes a second averaging readout of reading out a signal at the first spatial position by averaging the signal in B pixels and reading out a signal at the second spatial position by averaging the signals in A pixels,
in the thinning-out readout, at least the signals are not read out from the pixels disposed between the A pixels and the pixels disposed between the B pixels, and
in a case where both the second averaging readout and the thinning-out readout are performed, k is 1 or more.
   (6)

The optical filter according to any one of (1) to (5),
in which A is set to a natural number of 2 or more,
the averaging readout includes a third averaging readout of reading out a signal at the first spatial position by averaging the signals in A pixels and reading out a signal at the second spatial position by averaging the signals in the A pixels,
in the thinning-out readout, at least the signals are not read out from the pixels disposed between the A pixels, and
in a case where both the third averaging readout and the thinning-out readout are performed, k is 0.
   (7)

The optical filter according to any one of (1) to (6),
in which at least one of n or L is configured to be changeable.
   (8)

The optical filter according to (7),
in which the optical filter includes a plurality of optical members, and the characteristic is obtained from a combination of the plurality of optical members.
   (9)

The optical filter according to (8),
in which at least one of n or L is changed by changing the disposition of the plurality of optical members.
   (10)

The optical filter according to (8) or (9),
in which at least one of n or L is changed by an electrical control of any of the plurality of optical members.
   (11)

The optical filter according to any one of (2) to (6),
in which at least one of n or Lis configured to be changeable.
   (12)

An imaging apparatus comprising:
the optical filter according to any one of (1) to (10);
the imaging element; and
a processor configured to control the imaging element and the optical filter.
   (13)

The imaging apparatus according to (12),
in which the processor is configured to change at least one of n or L based on a drive mode of the imaging element.
   (14)

The imaging apparatus according to (13),
in which the processor is configured to, in a case where the drive mode of the imaging element is switched from a first mode to a second mode, change at least one of n or L from a value set in the first mode before imaging for recording is performed by the imaging element after driving of the imaging element in the second mode is started.
   (15)

An imaging apparatus comprising:
the optical filter according to any one of (1) to (10);
the imaging element; and
a processor configured to control the imaging element.
   (16)

An imaging system comprising:
the optical filter according to any one of (1) to (10);
the imaging element; and
a processor configured to control the imaging element and the optical filter.

### BRIEF DESCRIPTION OF THE DRAWINGS

FIG. 1 is a diagram showing a schematic configuration of a digital camera 100 which is an embodiment of an imaging apparatus and an imaging system according to the present invention.

FIG. 2 is a schematic plan view showing a schematic configuration of an imaging element 5 shown in FIG. 1.

FIG. 3 is a schematic diagram showing a partially enlarged imaging surface 60 of the imaging element 5 shown in FIG. 2.

FIG. 4 is a schematic diagram for describing a drive mode in which pixel signals are individually read out from all pixel rows 62.

FIG. 5 is a schematic diagram for describing a drive mode in which thinning-out readout is performed.

FIG. 6 is a schematic diagram for describing a drive mode in which the thinning-out readout and averaging readout are performed in combination.

FIG. 7 is a schematic diagram for describing a drive mode in which the thinning-out readout and the averaging readout are performed in combination.

FIG. 8 is a schematic diagram for describing a drive mode in which the thinning-out readout and the averaging readout are performed in combination.

FIG. 9 is a schematic diagram for describing a drive mode in which the thinning-out readout and the averaging readout are performed in combination.

FIG. 10 is a schematic diagram for describing a drive mode in which the thinning-out readout and the averaging readout are performed in combination.

FIG. 11 is a schematic diagram for describing a drive mode in which the thinning-out readout is performed.

FIG. 12 is a schematic diagram for describing a drive mode in which the thinning-out readout and the averaging readout are performed in combination.

FIG. 13 is a diagram showing a frequency characteristic of an optical low-pass filter 7 in a case where pixel signals are read out in the drive mode in FIG. 5.

FIG. 14 is a diagram showing a frequency characteristic of the optical low-pass filter 7 in a case where pixel signals are read out in the drive mode in FIG. 6.

FIG. 15 is a diagram showing a frequency characteristic of the optical low-pass filter 7 in a case where pixel signals are read out in the drive mode in FIG. 8.

FIG. 16 is a diagram showing a frequency characteristic of the optical low-pass filter 7 in a case where pixel signals are read out in the drive mode in FIG. 9.

FIG. 17 is a schematic diagram showing a configuration example of the optical low-pass filter 7.

FIG. 18 is a schematic diagram showing another configuration example of the optical low-pass filter 7.

FIG. 19 is a diagram showing an exterior of a smartphone 200.

FIG. 20 is a block diagram showing a configuration of the smartphone 200 shown in FIG. 19.

### DESCRIPTION OF THE PREFERRED EMBODIMENTS

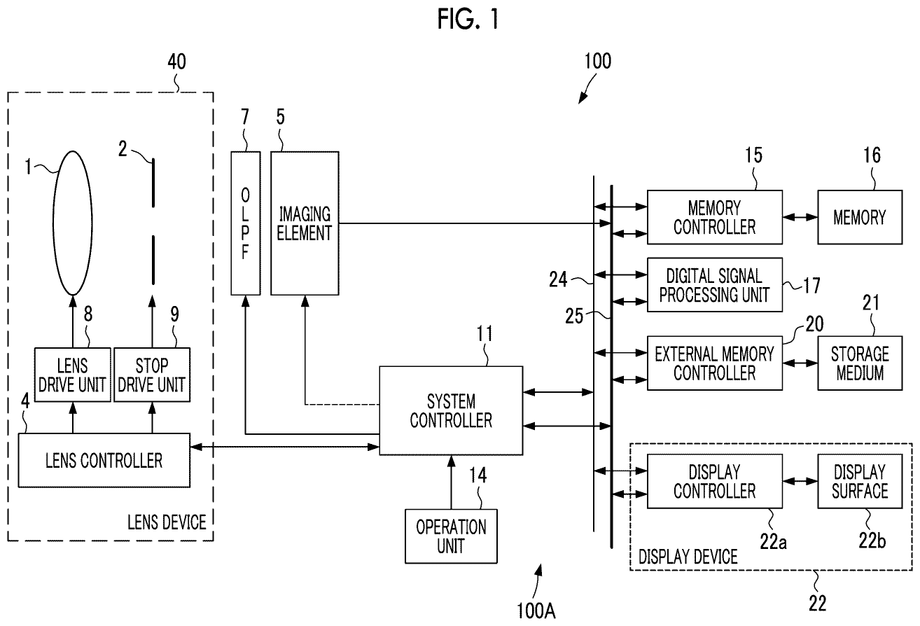

FIG. 1 is a diagram showing a schematic configuration of a digital camera 100 which is an embodiment of an imaging apparatus and an imaging system. The digital camera 100 shown in FIG. 1 comprises a lens device 40 including an imaging lens 1, a stop 2, a lens drive unit 8 that drives the imaging lens 1, a stop drive unit 9 that drives the stop 2, and a lens controller 4 that controls the lens drive unit 8 and the stop drive unit 9, and a body part 100A.

The body part 100A comprises an imaging element 5, an optical low-pass filter (OLPF) 7 disposed on a subject side from the imaging element 5, a system controller 11 that manages and controls the entire electrical control system of the digital camera 100, an operation unit 14, a display device 22, a memory 16 including a random access memory (RAM), a read only memory (ROM), and the like, a memory controller 15 that controls data storage in the memory 16 and data readout from the memory 16, a digital signal processing unit 17, and an external memory controller 20 that controls data storage in a storage medium 21 and data readout from the storage medium 21.

The lens device 40 may be attachable to and detachable from the body part 100A or may be integrated with the body part 100A. The imaging lens 1 may include at least one of a focus lens or a zoom lens that is movable in an optical axis direction. The optical low-pass filter 7 may be provided in the lens device 40.

The focus lens is a lens for adjusting a focal point of an imaging optical system including the imaging lens 1 and the stop 2, and is composed of a single lens or of a plurality of lenses. By moving the focus lens in the optical axis direction, a position of a principal point of the focus lens (hereinafter, also referred to as a focus lens position) changes along the optical axis direction, and a focal position on a subject side is changed. A liquid lens of which a position of a principal point in the optical axis direction can be changed by electrical control may be used as the focus lens.

The zoom lens is a lens for changing a focal length of the imaging optical system including the imaging lens 1 and the stop 2, and is composed of a single lens or of a plurality of lenses. By moving the zoom lens in the optical axis direction, the zoom magnification is changed.

The lens controller 4 of the lens device 40 changes the focus lens position or the zoom lens position by controlling the lens drive unit 8 based on a lens drive signal transmitted from the system controller 11. The lens controller 4 of the lens device 40 changes an amount of opening (F value) of the stop 2 by controlling the stop drive unit 9 based on a driving control signal transmitted from the system controller 11.

In a case where the optical low-pass filter 7 is provided in the lens device 40, the lens controller 4 controls the optical low-pass filter 7 based on the OLPF control signal transmitted from the system controller 11 to control the characteristics of separation of a point image in the optical low-pass filter 7.

The optical low-pass filter 7 is configured to change the characteristics (at least one of n or L described later) of the separation of the point image.

The optical low-pass filter 7 can obtain the above-described characteristics by, for example, a combination of a plurality of optical members. The optical low-pass filter 7 can change the above-described characteristics, for example, by changing the disposition of the plurality of optical members. Alternatively, the optical low-pass filter 7 can change the above-described characteristics by the electrical control of any of the plurality of optical members. A configuration example of the optical low-pass filter 7 will be described later.

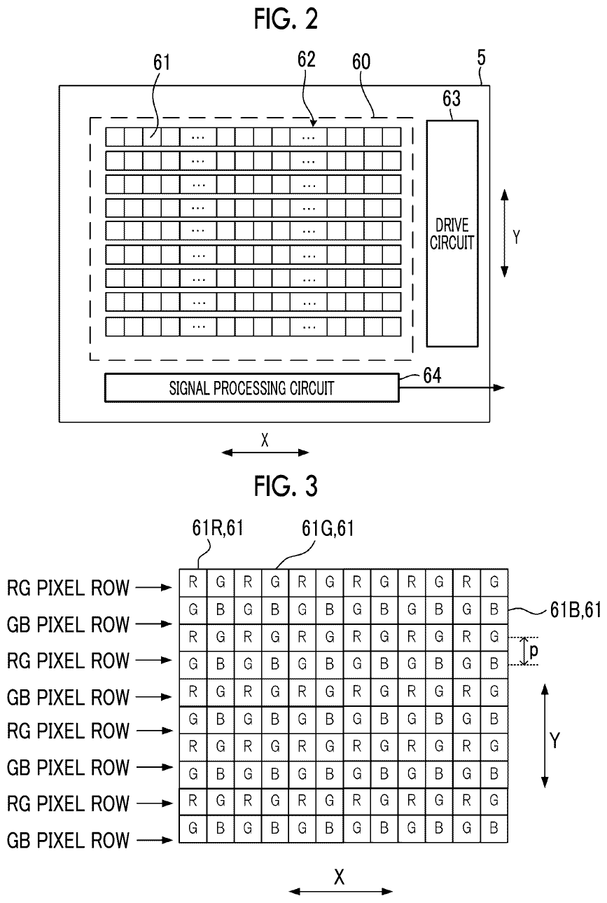

The imaging element 5 images a subject through the imaging optical system including the imaging lens 1, the stop 2, and the optical low-pass filter 7. The imaging element 5 includes an imaging surface 60 (refer to FIG. 2) on which a plurality of pixels are two-dimensionally arranged, converts a subject image formed on the imaging surface 60 by the imaging optical system into image signals by the plurality of pixels, and outputs the image signals.

For example, a complementary metal-oxide semiconductor (CMOS) image sensor or a charge coupled device (CCD) image sensor is used as the imaging element 5. Hereinafter, an example in which the imaging element 5 is a CMOS image sensor will be described.

The system controller 11 manages and controls the entire digital camera 100 and executes various types of processing such as control of the imaging element 5, control of the optical low-pass filter 7, and control of the lens device 40.

In the present embodiment, each processing (each control) of the system controller 11 is executed by any computer. In addition, any computer may execute the processing by a processor, a program, or a combination thereof. Any computer may be a general-purpose computer, a computer for a specific use, a system such as a workstation, or other hardware elements capable of executing a program.

The processor may be configured by one or a plurality of pieces of hardware, and the type of hardware is not limited. For example, the processor may be configured by hardware such as a central processing unit (CPU), a micro processing unit (MPU), a programmable logic device such as a field programmable gate array (FPGA), a dedicated circuit for executing specific processing such as an application specific integrated circuit (ASIC), a graphic processing unit (GPU), or a neural processing unit (NPU). In addition, the processor has each unit or each means that executes various types of processing in the present embodiment. In addition, the types of hardware may be a combination of different types of hardware. In a case where a plurality of pieces of hardware are configured to execute one or a plurality of types of processing of a certain processor, the plurality of pieces of hardware may be present in devices physically separated from each other, or may be present in the same device. In addition, in any of the embodiments, the order of each processing by the processor is not limited to the above order, and may be appropriately changed. The hardware is configured by an electric circuit (circuitry) in which circuit elements such as semiconductor elements are combined.

Further, the present embodiment may be realized by hardware, software, firmware, microcode, or a combination thereof. Software, firmware, and microcode are configured by a program. In addition, the program may be, for example, a program module group, and each function thereof may be realized by a processor configured to execute each function. The program may be a program code or a plurality of code segments stored in one or a plurality of non-transitory computer-readable media (for example, a storage medium or other storage). The program may be divided and stored in the plurality of non-transitory computer-readable media present in devices physically separated from each other. The program code or code segment may represent any combination of a procedure, a function, a subprogram, a routine, a subroutine, a module, a software package, a class, or an instruction, a data structure, or a program statement. The program code or code segment may be connected to another code segment or a hardware circuit by transmitting and receiving information, data, an argument, a parameter, or a content of a memory.

The system controller 11 drives the imaging element 5 and the lens device 40 and outputs the subject image captured through the imaging optical system of the lens device 40 as the image signal. By processing the image signal output from the imaging element 5 via the digital signal processing unit 17, captured image data that is data suitable for display on the display device 22 or is data suitable for storage in the storage medium 21 is generated.

An instruction signal from a user is input to the system controller 11 through the operation unit 14. The operation unit 14 includes a touch panel integrated with a display surface 22b, and various buttons and the like.

The display device 22 comprises the display surface 22b configured with an organic electroluminescence (EL) panel, a liquid crystal panel, or the like, and a display controller 22a that controls display on the display surface 22b.

The memory controller 15, the digital signal processing unit 17, the external memory controller 20, and the display controller 22a are connected to each other through a control bus 24 and through a data bus 25 and are controlled in accordance with instructions from the system controller 11.

Each processing performed by the system controller 11 may be performed by a server or the like at a place different from the digital camera 100. In this case, the digital camera 100 performs the control of the imaging element 5 and the optical low-pass filter 7 in accordance with instructions from the server. In this case, an imaging system is configured by the imaging element 5, the optical low-pass filter 7, and the server.

FIG. 2 is a schematic plan view showing a schematic configuration of the imaging element 5 shown in FIG. 1. The imaging element 5 comprises an imaging surface 60 on which a plurality of pixel rows 62 consisting of a plurality of pixels 61 arranged in a row direction X are arranged in a column direction Y intersecting (in the example in the drawing, orthogonal to) the row direction X, a drive circuit 63 that drives the pixels 61 arranged on the imaging surface 60, and a signal processing circuit 64 that processes pixel signals read out to signal lines from the respective pixels 61 of the pixel rows 62 arranged on the imaging surface 60. The column direction Y constitutes a first direction.

The pixel signal read out from the pixel 61 to the signal line is an analog signal. The signal processing circuit 64 includes a converter that converts an analog signal into a digital signal. The pixel signal read out from the pixel 61 is subjected to digital conversion by the signal processing circuit 64 and is output to the outside of the imaging element 5 as a digital signal.

FIG. 3 is a schematic diagram showing a partially enlarged imaging surface 60 of the imaging element 5 shown in FIG. 2. The plurality of pixels 61 disposed on the imaging surface 60 include pixels each corresponding to a plurality (three in the present embodiment) of wavelength ranges.

Specifically, the imaging surface 60 is provided with a pixel 61R (blocks with a character “R” in the drawing) corresponding to a wavelength range of red light, a pixel 61G (blocks with a character “G” in the drawing) corresponding to a wavelength range of green light, and a pixel 61B (blocks with a character “B” in the drawing) corresponding to a wavelength range of blue light.

On the imaging surface 60, an RG pixel row in which the pixel 61R and the pixel 61G are alternately arranged in the row direction X and a GB pixel row in which the pixel 61G and the pixel 61B are alternately arranged in the row direction X are alternately arranged in the column direction Y.

Each pixel 61 provided on the imaging surface 60 receives light in the corresponding wavelength range and outputs a pixel signal corresponding to the amount of the light. The plurality of pixels 61 are arranged in the column direction Y at a pixel pitch p. That is, a distance between the adjacent GB pixel row and RG pixel row in the column direction Y is “p”.

The system controller 11 can drive the imaging element 5 in a plurality of drive modes.

The plurality of drive modes include a drive mode in which pixel signals are individually read out from all the pixels 61, a drive mode in which averaging readout in which pixel signals of a plurality of pixels 61 arranged in the column direction Y are averaged and read out is performed, a drive mode in which thinning-out readout in which pixel signals are read out from a part of the plurality of pixels 61 arranged in the column direction Y and the pixel signals are not read out from parts other than the part of the plurality of pixels 61 is performed, and a drive mode in which the averaging readout and the thinning-out readout are performed in combination.

Hereinafter, details of the drive modes of the imaging element 5 will be described. In the following description, a spatial position of the pixel signal output from the pixel 61 of the RG pixel row in the column direction Y among the pixel signals output from the imaging element 5 in each drive mode is referred to as a first spatial position P1. In addition, a spatial position of the pixel signal output from the pixel 61 of the GB pixel row in the column direction Y is referred to as a second spatial position P2. In each of the following drawings, ★ indicates the first spatial position P1, and [symbol] indicates the second spatial position P2.

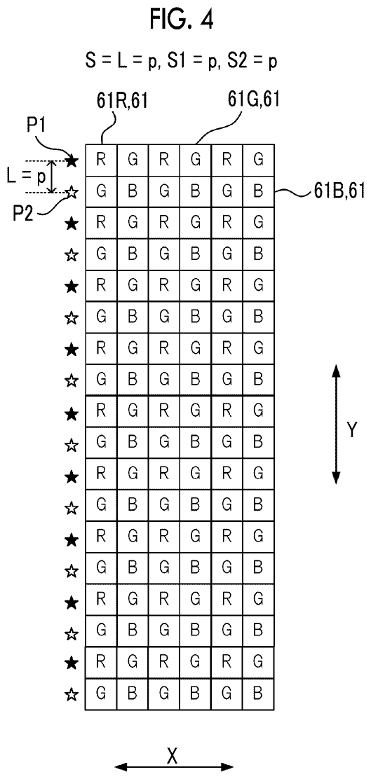

FIG. 4 is a schematic diagram for describing a drive mode in which pixel signals are individually read out from all the pixel rows 62. In this drive mode, in the pixel signal column arranged in the column direction Y among the image signal output from the imaging element 5, the distance L between the spatial positions of the pixel signals is the same as the pixel pitch p.

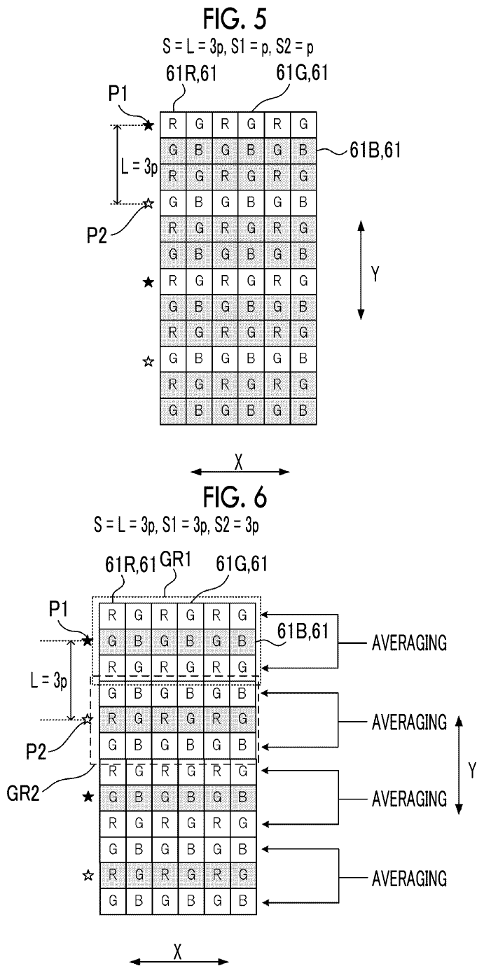

FIG. 5 is a schematic diagram for describing a drive mode in which the thinning-out readout is performed. In the drawing, the pixel 61 that is not hatched means that the pixel signal is read out, and the pixel 61 that is hatched means that the pixel signal is not read out. The same applies to the subsequent drawings.

In the drive mode in FIG. 5, an example in which the pixel signals are read out in a ratio of one to three pixel rows 62 is shown. In the drive mode in FIG. 5, the spatial position of the pixel signal read out from each pixel 61 is the position of the pixel 61 in the column direction Y.

In the drive mode in FIG. 5, in the pixel signal column output from the imaging element 5, the distance L between the spatial positions of the pixel signals is three times the pixel pitch p.

FIG. 6 is a schematic diagram for describing a drive mode in which the thinning-out readout and the averaging readout are performed in combination. In the drive mode in FIG. 6, all the pixel rows 62 are divided into a first group GR1 and a second group GR2 alternately arranged in the column direction Y, and the pixel signals are read out in units of these groups.

The first group GR1 consists of two RG pixel rows adjacent to each other in the column direction Y and a GB pixel row therebetween. The second group GR2 consists of two GB pixel rows adjacent to each other in the column direction Y and an RG pixel row therebetween. The pixel row 62 is not present between the first group GR1 and the second group GR2.

In the first group GR1, the averaging of the pixel signals is performed between the pixels 61 corresponding to the same color in the two RG pixel rows, and the pixel signals are not read out from the GB pixel row between the two RG pixel rows. The first spatial position P1 of the pixel signal read out from the first group GR1 is an intermediate position of the two RG pixel rows of the first group GR1.

In the second group GR2, the averaging of the pixel signals is performed between the pixels 61 corresponding to the same color in the two GB pixel rows, and the pixel signals are not read out from the RG pixel row between the two GB pixel rows. The second spatial position P2 of the pixel signal read out from the second group GR2 is an intermediate position of the two GB pixel rows of the second group GR2.

In the drive mode in FIG. 6, in the pixel signal column output from the imaging element 5, the distance L between the spatial positions of the pixel signals is three times the pixel pitch p.

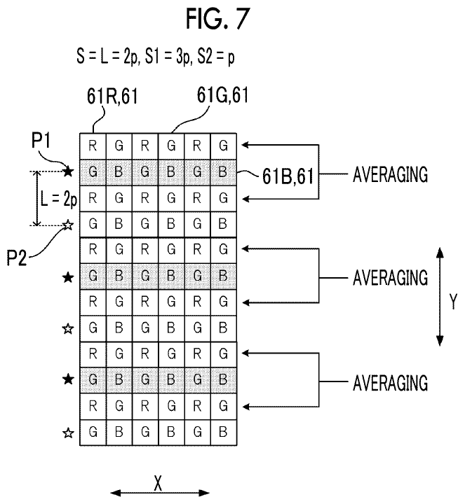

FIG. 7 is a schematic diagram for describing a drive mode in which the thinning-out readout and the averaging readout are performed in combination. In the drive mode in FIG. 7, the averaging of the pixel signals is performed between the pixels 61 corresponding to the same color in the two RG pixel rows adjacent to each other in the column direction Y, and the pixel signals are not read out from the GB pixel row between the two RG pixel rows. The first spatial position P1 of the pixel signal read out by averaging the two RG pixel rows is an intermediate position of the two RG pixel rows.

In addition, in the drive mode in FIG. 7, the pixel signal is read out alone from the GB pixel rows other than the GB pixel rows interposed between the two RG pixel rows to be averaged. The second spatial position P2 of the pixel signal read out from the GB pixel row is a position in the column direction Y of the GB pixel row.

In the drive mode in FIG. 7, in the pixel signal column output from the imaging element 5, the distance L between the spatial positions of the pixel signals is twice the pixel pitch p.

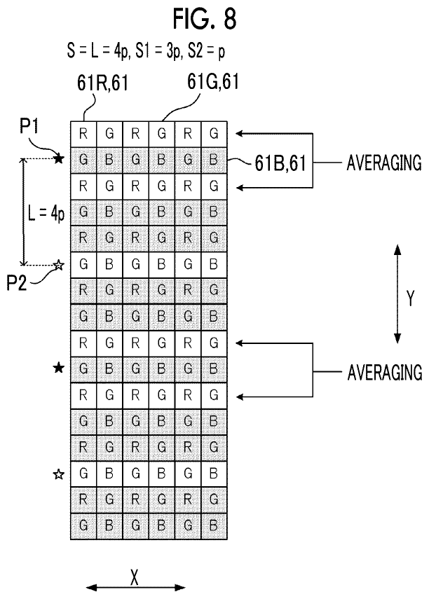

FIG. 8 is a schematic diagram for describing a drive mode in which the thinning-out readout and the averaging readout are performed in combination. In the drive mode in FIG. 8, two RG pixel rows adjacent to each other in the column direction Y are set as one RG set, and the pixel signals are read out in a ratio of one to two RG sets.

In the RG set in which the pixel signal is read out, the averaging of the pixel signals is performed between the pixels 61 corresponding to the same color, and the pixel signals are not read out from the GB pixel rows between the RG pixel rows constituting the RG set. The first spatial position P1 of the pixel signal read out by averaging from the RG set is an intermediate position of the two RG pixel rows constituting the RG set.

In addition, in the drive mode in FIG. 8, for the GB pixel row, the pixel signal is read out alone only from the GB pixel row disposed between the two RG pixel rows constituting the RG set of which the pixel signal is not read out among the two RG sets. The second spatial position P2 of the pixel signal read out from the GB pixel row is a position in the column direction Y of the GB pixel row.

In the drive mode in FIG. 8, in the pixel signal column output from the imaging element 5, the distance L between the spatial positions of the pixel signals is four times the pixel pitch p.

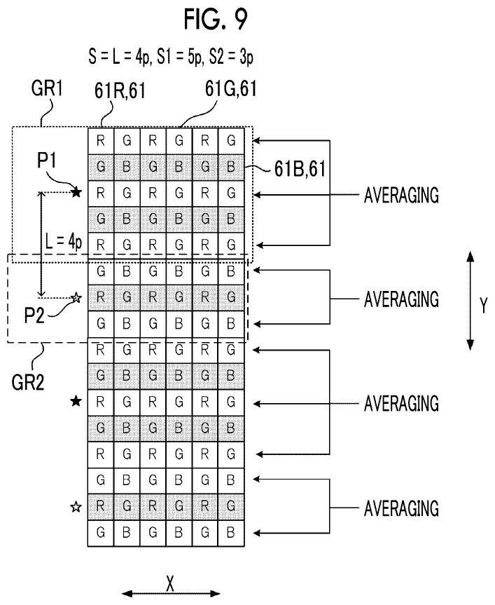

FIG. 9 is a schematic diagram for describing a drive mode in which the thinning-out readout and the averaging readout are performed in combination. In the drive mode in FIG. 9, all the pixel rows 62 are divided into the first group GR1 and the second group GR2 alternately arranged in the column direction Y, and the pixel signals are read out in units of these groups.

The first group GR1 consists of three RG pixel rows adjacent to each other in the column direction Y and two GB pixel rows therebetween. The second group GR2 consists of two GB pixel rows adjacent to each other in the column direction Y and one RG pixel row therebetween. The pixel row 62 is not present between the first group GR1 and the second group GR2.

In the first group GR1, the averaging of the pixel signals is performed between the pixels 61 corresponding to the same color in the three RG pixel rows, and the pixel signals are not read out from the two GB pixel rows between the three RG pixel rows. The first spatial position P1 of the pixel signal read out from the first group GR1 is a position in the column direction Y of the middle RG pixel row among the three RG pixel rows of the first group GR1.

In the second group GR2, the averaging of the pixel signals is performed between the pixels 61 corresponding to the same color in the two GB pixel rows, and the pixel signals are not read out from one RG pixel row between the two GB pixel rows. The second spatial position P2 of the pixel signal read out from the second group GR2 is an intermediate position of the two GB pixel rows of the second group GR2.

In the drive mode in FIG. 9, in the pixel signal column output from the imaging element 5, the distance L between the spatial positions of the pixel signals is four times the pixel pitch p.

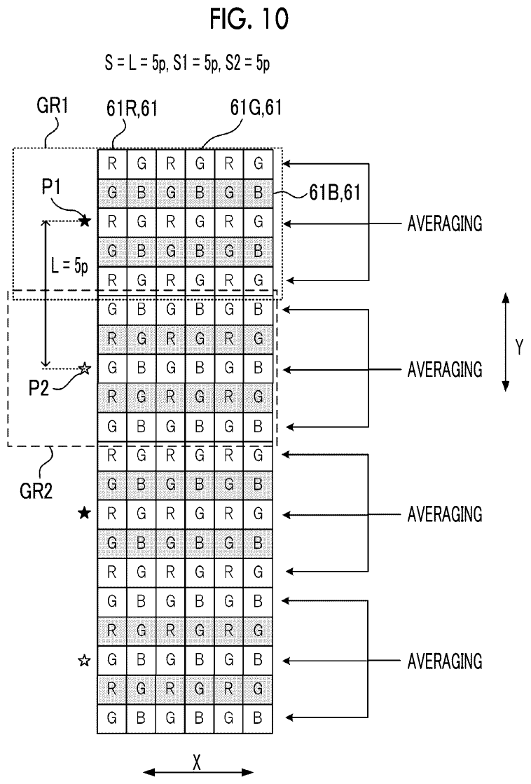

FIG. 10 is a schematic diagram for describing a drive mode in which the thinning-out readout and the averaging readout are performed in combination. In the drive mode shown in FIG. 10, all the pixel rows 62 are divided into the first group GR1 and the second group GR2 alternately arranged in the column direction Y, and the pixel signals are read out in units of these groups.

The first group GR1 consists of three RG pixel rows adjacent to each other in the column direction Y and two GB pixel rows therebetween. The second group GR2 consists of three GB pixel rows adjacent to each other in the column direction Y and two RG pixel rows therebetween. The pixel row 62 is not present between the first group GR1 and the second group GR2.

In the first group GR1, the averaging of the pixel signals is performed between the pixels 61 corresponding to the same color in the three RG pixel rows, and the pixel signals are not read out from the two GB pixel rows between the three RG pixel rows. The first spatial position P1 of the pixel signal read out from the first group GR1 is a position in the column direction Y of the middle RG pixel row among the three RG pixel rows of the first group GR1.

In the second group GR2, the averaging of the pixel signals is performed between the pixels 61 corresponding to the same color in the three GB pixel rows, and the pixel signals are not read out from the two RG pixel rows between the three GB pixel rows. The second spatial position P2 of the pixel signal read out from the second group GR2 is a position in the column direction Y of the middle GB pixel row among the three GB pixel rows of the second group GR2.

In the drive mode in FIG. 10, in the pixel signal column output from the imaging element 5, the distance L between the spatial positions of the pixel signals is five times the pixel pitch p.

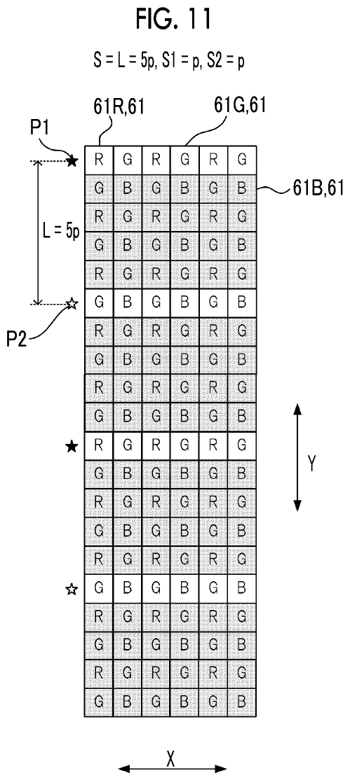

FIG. 11 is a schematic diagram for describing a drive mode in which the thinning-out readout is performed. In the example of FIG. 11, an example in which the pixel signals are read out in a ratio of one to five pixel rows 62 is shown. In the drive mode in FIG. 11, in the pixel signal column output from the imaging element 5, the distance L between the spatial positions of the pixel signals is five times the pixel pitch p.

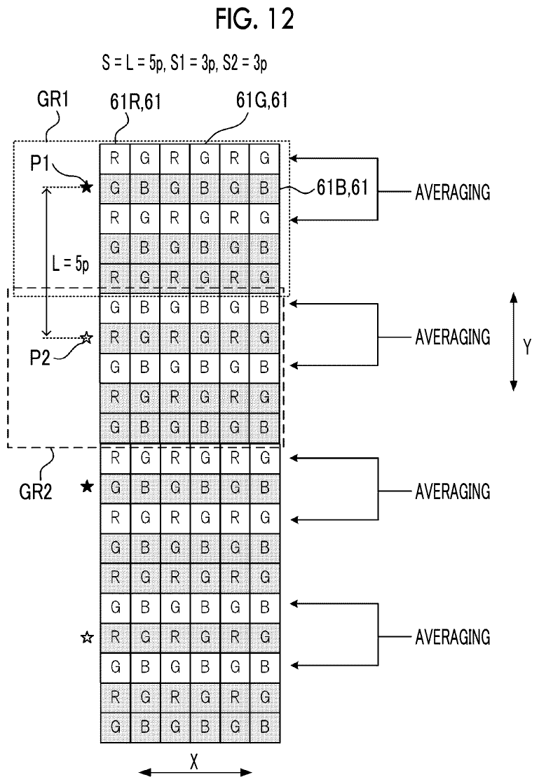

FIG. 12 is a schematic diagram for describing a drive mode in which the thinning-out readout and the averaging readout are performed in combination. In the drive mode shown in FIG. 12, all the pixel rows 62 are divided into the first group GR1 and the second group GR2 alternately arranged in the column direction Y, and the pixel signals are read out in units of these groups.

The first group GR1 consists of three RG pixel rows adjacent to each other in the column direction Y and two GB pixel rows therebetween. The second group GR2 consists of three GB pixel rows adjacent to each other in the column direction Y and two RG pixel rows therebetween. The pixel row 62 is not present between the first group GR1 and the second group GR2.

In the first group GR1, the averaging of the pixel signals is performed between the pixels 61 corresponding to the same color in the two RG pixel rows adjacent to each other in the column direction Y, and the pixel signals are not read out from three pixel rows 62 other than the two RG pixel rows. The first spatial position P1 of the pixel signal read out from the first group GR1 is an intermediate position of the two RG pixel rows averaged in the first group GR1.

In the second group GR2, the averaging of the pixel signals is performed between the pixels 61 corresponding to the same color in the two GB pixel rows adjacent to each other in the column direction Y, and the pixel signals are not read out from three pixel rows 62 other than the two GB pixel rows. The second spatial position P2 of the pixel signal read out from the second group GR2 is an intermediate position of the two GB pixel rows averaged in the second group GR2.

In the drive mode in FIG. 12, in the pixel signal column output from the imaging element 5, the distance L between the spatial positions of the pixel signals is five times the pixel pitch p.

It should be noted that, for the averaging of the pixel signals, any of a method of performing averaging by analog processing in the imaging element 5, a method of performing averaging by digital processing outside the imaging element 5, or the like can be employed.

Hereinafter, the distance L described above will also be referred to as a first opening size S. In addition, a value obtained by multiplying the number of pixels 61 of the generation source of the pixel signal at the first spatial position P1 by the pixel pitch p is defined as a second opening size S1. In addition, a value obtained by multiplying the number of pixels 61 of the generation source of the pixel signal at the second spatial position P2 by the pixel pitch p is defined as a second opening size S2.

However, in a case where the pixel signal at the first spatial position P1 is obtained by averaging the pixel signals of the plurality of pixels 61 arranged in the column direction Y, a value obtained by multiplying the number obtained by adding the plurality of pixels 61 and the pixels 61 disposed therebetween by the pixel pitch p is defined as the second opening size S1.

In addition, in a case where the pixel signal at the second spatial position P2 is obtained by averaging the pixel signals of the plurality of pixels 61 arranged in the column direction Y, a value obtained by multiplying the number obtained by adding the plurality of pixels 61 and the pixels 61 disposed therebetween by the pixel pitch p is defined as the second opening size S2.

In a case where the definition is made in this way, in the drive modes in FIGS. 4, 5, and 11, the pixel signal at the first spatial position P1 is not averaged, and the number of pixels 61 as the generation source is one. Therefore, the second opening size S1 is “p”. In addition, the pixel signal at the second spatial position P2 is not averaged, and the number of pixels 61 as the generation source is one. Therefore, the second opening size S2 is “p”.

In the drive modes in FIGS. 6 and 12, the pixel signals at the first spatial position P1 are averaged, and the number of pixels 61 as the generation source is two. Therefore, the second opening size S1 is “3 p” obtained by multiplying the number “3” obtained by adding two pixels 61 of the generation source and one pixel 61 therebetween by the pixel pitch p. Similarly, the pixel signals at the second spatial position P2 are averaged, and the number of pixels 61 as the generation source is two. Therefore, the second opening size S2 is “3 p”.

In the drive modes in FIGS. 7 and 8, the pixel signals at the first spatial position P1 are averaged, and the number of pixels 61 as the generation source is two. Therefore, the second opening size S1 is “3 p” obtained by multiplying the number “3” obtained by adding two pixels 61 of the generation source and one pixel 61 therebetween by the pixel pitch p. On the other hand, the pixel signals at the second spatial position P2 are not averaged, and the number of pixels 61 as the generation source is one. Therefore, the second opening size S2 is “p”.

In the drive mode in FIG. 9, the pixel signals at the first spatial position P1 are averaged, and the number of pixels 61 as the generation source is three. Therefore, the second opening size S1 is “5 p” obtained by multiplying the number “5” obtained by adding three pixels 61 of the generation source and two pixels 61 therebetween by the pixel pitch p. In addition, the pixel signals at the second spatial position P2 are averaged, and the number of pixels 61 as the generation source is two. Therefore, the second opening size S2 is “3 p”.

In the drive mode in FIG. 10, the pixel signals at the first spatial position P1 are averaged, and the number of pixels 61 as the generation source is three. Therefore, the second opening size S1 is “5 p”. In addition, the pixel signals at the second spatial position P2 are averaged, and the number of pixels 61 as the generation source is three. Therefore, the second opening size S2 is “5 p”.

In a case where the definition is made as described above, the values in each drive mode are as follows. For convenience, these pieces of information are also described in each drawing.
Drive mode in FIG. 4: S=L=p, S1=p, S2=p
Drive mode in FIG. 5: S=L=3 p, S1=p, S2=p
Drive mode in FIG. 6: S=L=3 p, S1=3 p, S2=3 p
Drive mode in FIG. 7: S=L=2 p, S1=3 p, S2=p
Drive mode in FIG. 8: S=L=4 p, S1=3 p, S2=p
Drive mode in FIG. 9: S=L=4 p, S1=5 p, S2=3 p
Drive mode in FIG. 10: S=L=5 p, S1=5 p, S2=5 p
Drive mode in FIG. 11: S=L=5 p, S1=p, S2=p
Drive mode in FIG. 12: S=L=5 p, S1=3 p, S2=3 p

In a case where the second opening size S1 is smaller than the first opening size S, false resolution may occur in the RG pixel row caused by the size difference. In a case where the second opening size S2 is smaller than the first opening size S, false resolution may occur in the GB pixel row caused by the size difference. In addition, the false resolution may occur even in a case where the number of pixel signals constituting the pixel signal column output from the imaging element 5 is changed. Therefore, it is necessary for the optical low-pass filter 7 to have characteristics for suppressing this false resolution.

In the drive mode in FIG. 4, the first opening size S, the second opening size S1, and the second opening size S2 match each other. Therefore, the false resolution caused by the difference in the opening size is suppressed. Therefore, the characteristics required for the optical low-pass filter 7 in a case of reading out the pixel signal in the drive mode in FIG. 4 are only that two-point separation is performed on the point images at the separation width L (=p) in the column direction Y.

Accordingly, it is possible to suppress the false resolution caused by the number of pixel signals of the pixel signal column. In the optical low-pass filter 7, the characteristics for suppressing the false resolution caused by the number of pixel signals of the pixel signal column is referred to as output separation characteristics.

On the other hand, as shown in FIGS. 5 to 12, in a case where at least one of the averaging readout or the thinning-out readout is performed, the first opening size S is larger than that in the drive mode in FIG. 4. Therefore, it is necessary to determine the output separation characteristics in accordance with the size of the first opening size S.

In addition, as the first opening size S increases, a case where the first opening size S is larger than any of the second opening size S1 or the second opening size S2 occurs. In a case where the first opening size S is larger than the second opening size S1 or in a case where the first opening size S is larger than the second opening size S2, the false resolution may occur.

As described above, in a case where the false resolution caused by the difference in the opening size occurs, it is necessary for the optical low-pass filter 7 to further have separation characteristics of the point image for suppressing the false resolution. Characteristics for performing separation of point images for suppressing the false resolution caused by the difference in the opening size is referred to as opening difference separation characteristics.

For example, in the drive mode in FIG. 5, the second opening size S1 and the second opening size S2 are smaller than the first opening size S, and the difference therebetween is “2 p”. Therefore, in a case where the point image can be spread by “2 p” in the column direction Y, the false resolution caused by the difference in the opening size can be suppressed.

Therefore, in the drive mode in FIG. 5, the optical low-pass filter 7 has the opening difference separation characteristics of performing three-point separation at the separation width p and the output separation characteristics of performing two-point separation at the separation width L (=3 p). In this way, the false resolution can be suppressed.

In addition, in the drive mode in FIG. 6, the first opening size S, the second opening size S1, and the second opening size S2 match each other. In such a case, as in the case of the drive mode shown in FIG. 4, the false resolution caused by the difference in the opening size is suppressed. Therefore, in the drive mode in FIG. 6, the optical low-pass filter 7 need only have the output separation characteristics of performing two-point separation at the separation width L (=3 p).

In addition, in the drive mode in FIG. 7, since the second opening size S1 is larger than the first opening size S, the false resolution caused by the difference in the opening size is suppressed in the pixel 61 of the generation source of the signal at the first spatial position P1.

On the other hand, the second opening size S2 is smaller than the first opening size S, and the difference therebetween is “p”. Therefore, the false resolution may occur in the pixel 61 of the generation source of the signal at the second spatial position P2 caused by the difference in the opening size. In the drive mode in FIG. 7, in a case where the point image can be spread by “p” in the column direction Y, the false resolution caused by the difference in the opening size can be suppressed.

Therefore, in the drive mode in FIG. 7, the optical low-pass filter 7 has the opening difference separation characteristics of performing two-point separation at the separation width p and the output separation characteristics of performing two-point separation at the separation width L (=2 p), so that the false resolution can be suppressed.

In addition, in the drive mode in FIG. 8, the second opening size S1 is smaller than the first opening size S, and the difference therebetween is “p”. Therefore, the false resolution may occur in the pixel 61 of the generation source of the signal at the first spatial position P1 caused by the difference in the opening size.

In addition, the second opening size S2 is smaller than the first opening size S, and the difference therebetween is “3 p”. Therefore, the false resolution may occur in the pixel 61 of the generation source of the signal at the second spatial position P2 caused by the difference in the opening size.

In the drive mode in FIG. 8, in a case where the point image can be spread by “3 p” in the column direction Y, the false resolution caused by the difference in the opening size can be suppressed in both of the pixel 61 that is the generation source of the pixel signal at the first spatial position P1 and the pixel 61 that is the generation source of the pixel signal at the second spatial position P2.

Therefore, in the drive mode in FIG. 8, the optical low-pass filter 7 has the opening difference separation characteristics of performing two-point separation at the separation width p and the output separation characteristics of performing four-point separation at the separation width L (=4 p), so that the false resolution can be suppressed.

In addition, in the drive mode in FIG. 9, since the second opening size S1 is larger than the first opening size S, the false resolution caused by the difference in the opening size is suppressed in the pixel 61 of the generation source of the signal at the first spatial position P1.

On the other hand, the second opening size S2 is smaller than the first opening size S, and the difference therebetween is “p”. Therefore, the false resolution may occur in the pixel 61 of the generation source of the signal at the second spatial position P2 caused by the difference in the opening size.

In the drive mode shown in FIG. 9, in a case where the point image can be spread by “p” in the column direction Y, the false resolution caused by the difference in the opening size can be suppressed in the pixel 61 that is the generation source of the pixel signal at the second spatial position P2.

Therefore, in the drive mode in FIG. 9, the optical low-pass filter 7 has the opening difference separation characteristics of performing two-point separation at the separation width p and the output separation characteristics of performing two-point separation at the separation width L (=4 p), so that the false resolution can be suppressed.

In addition, in the drive mode in FIG. 10, the first opening size S, the second opening size S1, and the second opening size S2 match each other. In such a case, as in the cases of the drive modes shown in FIGS. 4 and 6, the false resolution caused by the difference in the opening size is suppressed.

Therefore, in the drive mode in FIG. 10, the optical low-pass filter 7 need only have the output separation characteristics of performing two-point separation at the separation width L (=5 p).

In addition, in the drive mode in FIG. 11, the second opening size S1 and the second opening size S2 are smaller than the first opening size S, and the difference therebetween is “4 p”. Therefore, in a case where the point image can be spread by “4 p” in the column direction Y, the false resolution caused by the difference in the opening size can be suppressed.

Therefore, in the drive mode in FIG. 11, the optical low-pass filter 7 has the opening difference separation characteristics of performing two-point separation at the separation width p and the output separation characteristics of performing five-point separation at the separation width L (=5 p), so that the false resolution can be suppressed.

In addition, in the drive mode in FIG. 12, the second opening size S1 and the second opening size S2 are smaller than the first opening size S, and the difference therebetween is “2 p”. Therefore, in a case where the point image can be spread by “2 p” in the column direction Y, the false resolution caused by the difference in the opening size can be suppressed.

Therefore, in the drive mode in FIG. 12, the optical low-pass filter 7 has the opening difference separation characteristics of performing two-point separation at the separation width p and the output separation characteristics of performing three-point separation at the separation width L (=5 p), so that the false resolution can be suppressed. In summary, the following is obtained.

```
Drive mode in FIG. 4: L = p, S1 = p, S2 = p
  → Characteristics of optical low-pass filter 7
  = Opening difference separation characteristics (no setting) + Output separation
```

characteristics (two-point separation at separation width L)

```
Drive mode in FIG. 5: L = 3p, S1 = p, S2 = p
  → Characteristics of optical low-pass filter 7
  = Opening difference separation characteristics (three-point separation at separation
```

width p) + Output separation characteristics (two-point separation at separation width L)

```
Drive mode in FIG. 6: L = 3p, S1 = 3p, S2 = 3p
  → Characteristics of optical low-pass filter 7
  = Opening difference separation characteristics (no setting) + Output separation
```

characteristics (two-point separation at separation width L)

```
Drive mode in FIG. 7: L = 2p, S1 = 3p, S2 = p
  → Characteristics of optical low-pass filter 7
  = Opening difference separation characteristics (two-point separation at separation
```

width p) + Output separation characteristics (two-point separation at separation width L)

```
Drive mode in FIG. 8: L = 4p, S1 = 3p, S2 = p
  → Characteristics of optical low-pass filter 7
  = Opening difference separation characteristics (four-point separation at separation
```

width p) + Output separation characteristics (two-point separation at separation width L)

```
Drive mode in FIG. 9: L = 4p, S1 = 5p, S2 = 3p
  → Characteristics of optical low-pass filter 7
  = Opening difference separation characteristics (two-point separation at separation
```

width p) + Output separation characteristics (two-point separation at separation width L)

```
Drive mode in FIG. 10: L = 5p, S1 = 5p, S2 = 5p
  → Characteristics of optical low-pass filter 7
  = Opening difference separation characteristics (no setting) + Output separation
```

characteristics (two-point separation at separation width L)

```
Drive mode in FIG. 11: L = 5p, S1 = p, S2 = p
  → Characteristics of optical low-pass filter 7
  = Opening difference separation characteristics (five-point separation at separation
```

width p) + Output separation characteristics (two-point separation at separation width L)

```
Drive mode in FIG. 12: L = 5p, S1 = 3p, S2 = 3p
  → Characteristics of optical low-pass filter 7
  = Opening difference separation characteristics (three-point separation at separation
```

width p) + Output separation characteristics (two-point separation at separation width L)

As shown in FIGS. 5, 8, 11, and 12, in a case where there are pixel signals that are not read out between the first spatial position P1 and the second spatial position P2 adjacent to the first spatial position P1, the second opening size S1 and the second opening size S2 are smaller than the first opening size S.

In addition, as shown in FIGS. 7, 8, and 9, even in a case where there is a difference between the number of pixels 61 that are the generation sources of the pixel signals at the first spatial position P1 and the number of pixels 61 that are the generation sources of the pixel signals at the second spatial position P2, the second opening size S1 and the second opening size S2 may be smaller than the first opening size S.

That is, in the opening difference separation characteristics, it is necessary to determine the number of separations in accordance with the number of pixel rows 62 in which the pixel signals are not read out between the spatial positions and the difference in the number of pixels 61 that are the generation sources of the pixel signals at the first spatial position P1 and the number of pixels 61 that are the generation sources of the pixel signals at the second spatial position P2.

The number of pixels 61 in which the pixel signals are not read out between the pixel 61 that is the generation source of the pixel signal at the first spatial position P1 and the pixel 61 that is the generation source of the pixel signal at the second spatial position P2 adjacent to the first spatial position P1 is denoted by j. Further, an absolute value of a difference between the number of pixels 61 that are the generation sources of the pixel signals at the first spatial position P1 and the number of pixels 61 that are the generation sources of the pixel signals at the second spatial position P2 is denoted by k.

In a case where a sum of j and k is denoted by n, the optical low-pass filter 7 has the opening difference separation characteristics in which the point image is separated into (n+1) points with p as a separation width, so that it is possible to suppress the false resolution.

In the drive mode in FIG. 4, j=0 and k=0 are satisfied, so that n=0 is satisfied. Therefore, the opening difference separation characteristics are not set.

In the drive mode in FIG. 5, j=2 and k=0 are satisfied, so that n=2 is satisfied. Therefore, the opening difference separation characteristics are three-point separation at the separation width p.

In the drive mode in FIG. 6, j=0 and k=0 are satisfied, so that n=0 is satisfied. Therefore, the opening difference separation characteristics are not set.

In the drive mode in FIG. 7, j=0 and k=1 are satisfied, so that n=1 is satisfied. Therefore, the opening difference separation characteristics are two-point separation at the separation width p.

In the drive mode in FIG. 8, j=2 and k=1 are satisfied, so that n=3 is satisfied. Therefore, the opening difference separation characteristics are four-point separation at the separation width p.

In the drive mode in FIG. 9, j=0 and k=1 are satisfied, so that n=1 is satisfied. Therefore, the opening difference separation characteristics are two-point separation at the separation width p.

In the drive mode in FIG. 10, j=0 and k=0 are satisfied, so that n=0 is satisfied. Therefore, the opening difference separation characteristics are not set.

In the drive mode in FIG. 11, j=4 and k=0 are satisfied, so that n=4 is satisfied. Therefore, the opening difference separation characteristics are five-point separation at the separation width p.

In the drive mode in FIG. 12, j=2 and k=0 are satisfied, so that n=2 is satisfied. Therefore, the opening difference separation characteristics are three-point separation at the separation width p.

In addition, the separation width is denoted by p for the opening difference separation characteristics and the separation width is denoted by L for the output separation characteristics. However, the present invention is not limited thereto. Even in a case where a numerical value greater than 0.7 and smaller than 1 is denoted by a, the separation width for the opening difference separation characteristics is denoted by α×p, and the separation width for the output separation characteristics is denoted by α×L, it is possible to suppress the false resolution.

FIG. 13 is a diagram showing a frequency characteristic of the optical low-pass filter 7 in a case where pixel signals are read out in the drive mode in FIG. 5. In the drawing, a horizontal axis represents a spatial frequency, and a vertical axis represents a response. A broken line in the drawing indicates a response of each pixel 61 from which the pixel signal is read out.

In a case where the imaging element 5 is driven by the drive mode in FIG. 5, the frequency characteristic indicated by a solid line in FIG. 13 is obtained by providing the optical low-pass filter 7 with the characteristics of performing three-point separation at the separation width p and two-point separation at the separation width L (=3 p).

As shown in FIG. 13, the response of the optical low-pass filter 7 is low in a frequency range in which the response of each pixel 61 is high. As a result, it is possible to suppress the false resolution.

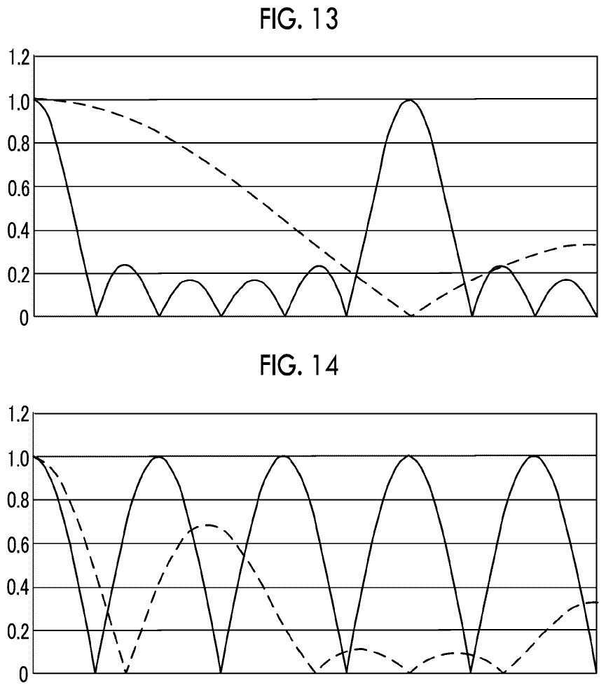

FIG. 14 is a diagram showing a frequency characteristic of the optical low-pass filter 7 in a case where pixel signals are read out in the drive mode in FIG. 6. In the drawing, a horizontal axis represents a spatial frequency, and a vertical axis represents a response. A broken line in the drawing indicates a response of each pixel 61 from which the pixel signal is read out.

In a case where the imaging element 5 is driven by the drive mode in FIG. 6, the frequency characteristic indicated by a solid line in FIG. 14 is obtained by providing the optical low-pass filter 7 with the characteristic of two-point separation at the separation width L (=3 p).

As shown in FIG. 14, the response of the optical low-pass filter 7 is low in a frequency range in which the response of each pixel 61 is high. As a result, it is possible to suppress the false resolution.

FIG. 15 is a diagram showing a frequency characteristic of the optical low-pass filter 7 in a case where pixel signals are read out in the drive mode in FIG. 8. In the drawing, a horizontal axis represents a spatial frequency, and a vertical axis represents a response. A broken line in the drawing indicates a response of each pixel 61 of the GB pixel row. A one-dot chain line in the drawing indicates a response of each pixel 61 of the RG pixel row.

In a case where the imaging element 5 is driven by the drive mode in FIG. 8, the frequency characteristic indicated by a solid line in FIG. 15 is obtained by providing the optical low-pass filter 7 with the characteristics of performing four-point separation at the separation width p and two-point separation at the separation width L (=4 p).

As shown in FIG. 15, the response of the optical low-pass filter 7 is low in a frequency range in which the response of each of the RG pixel row and the GB pixel row is high. As a result, it is possible to suppress the false resolution.

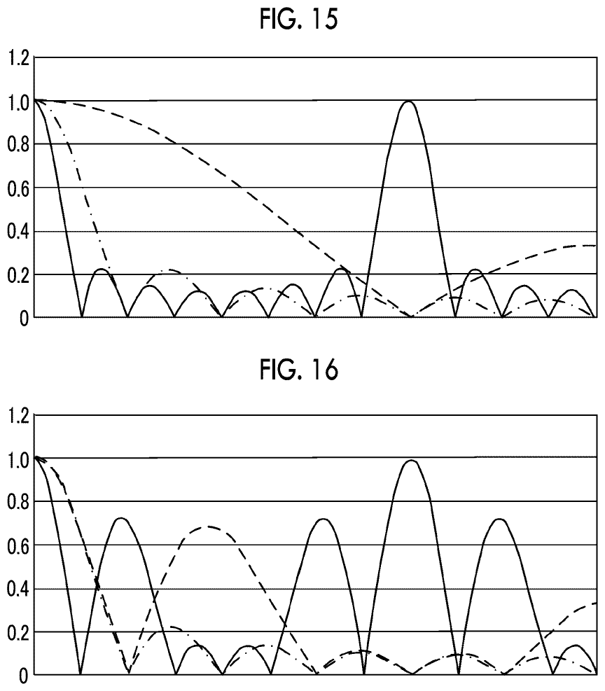

FIG. 16 is a diagram showing a frequency characteristic of the optical low-pass filter 7 in a case where pixel signals are read out in the drive mode in FIG. 9. In the drawing, a horizontal axis represents a spatial frequency, and a vertical axis represents a response. A broken line in the drawing indicates a response of each pixel 61 of the GB pixel row. A one-dot chain line in the drawing indicates a response of each pixel 61 of the RG pixel row.

In a case where the imaging element 5 is driven by the drive mode in FIG. 9, the frequency characteristic indicated by a solid line in FIG. 16 is obtained by providing the optical low-pass filter 7 with the characteristics of performing two-point separation at the separation width p and two-point separation at the separation width L (=4 p).

As shown in FIG. 16, the response of the optical low-pass filter 7 is low in a frequency range in which the response of each of the RG pixel row and the GB pixel row is high. As a result, it is possible to suppress the false resolution.

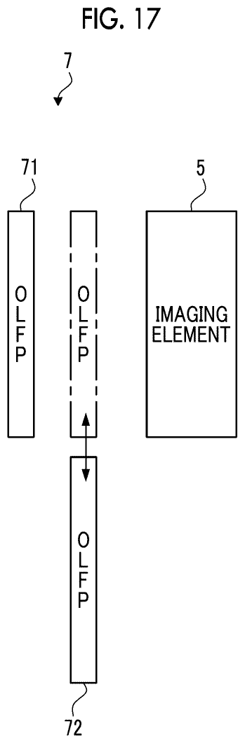

FIG. 17 is a schematic diagram showing the configuration example of the optical low-pass filter 7. The optical low-pass filter 7 is configured by combining a first optical low-pass filter 71 and a second optical low-pass filter 72. The second optical low-pass filter 72 is configured to be inserted into and removed from between the first optical low-pass filter 71 and the imaging element 5. The first optical low-pass filter 71 and the second optical low-pass filter 72 each constitute an optical member.

The first optical low-pass filter 71 is provided, for example, to obtain the output separation characteristics. The second optical low-pass filter 72 is provided, for example, to obtain the opening difference separation characteristics.

The first optical low-pass filter 71 has, for example, the output separation characteristics of performing two-point separation at a separation width “p”, “2 p”, “3 p”, “4 p”, or “5 p”. The second optical low-pass filter 72 has, for example, the opening difference separation characteristics of performing two-point, three-point, four-point, or five-point separation at the separation width p.

For example, the separation width of the first optical low-pass filter 71 is set to “3 p”, and the number of separations of the second optical low-pass filter 72 is set to three points. In this example, in a case where the imaging element 5 is driven by the drive mode in FIG. 6, the second optical low-pass filter 72 is retracted from between the first optical low-pass filter 71 and the imaging element 5. As a result, the optical low-pass filter 7 has characteristics of performing two-point separation at a separation width 3 p (=L).

In addition, in a case where the imaging element 5 is driven by the drive mode in FIG. 5, the second optical low-pass filter 72 is disposed between the first optical low-pass filter 71 and the imaging element 5. As a result, the optical low-pass filter 7 has characteristics of performing two-point separation at a separation width 3 p (=L) and three-point separation at a separation width p.

By increasing the number of types (the number of separations) of the second optical low-pass filters 72 that can be disposed between the first optical low-pass filter 71 and the imaging element 5, or by providing a plurality of types of the first optical low-pass filters 71 having different separation widths, the optical low-pass filter 7 can have various characteristics corresponding to the drive modes in FIGS. 4 to 12.

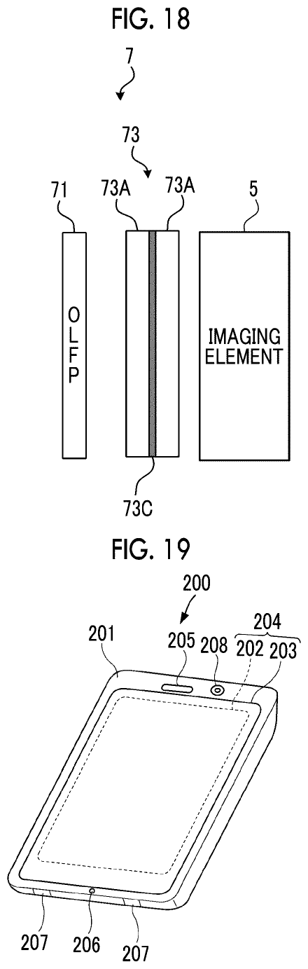

FIG. 18 is a schematic diagram showing another configuration example of the optical low-pass filter 7. The optical low-pass filter 7 shown in FIG. 18 comprises the first optical low-pass filter 71 and a third optical low-pass filter 73. Both the first optical low-pass filter 71 and the third optical low-pass filter 73 are provided between the imaging lens 1 and the imaging element 5. The first optical low-pass filter 71 and the third optical low-pass filter 73 each constitute an optical member.

The first optical low-pass filter 71 is provided, for example, to obtain the output separation characteristics. The third optical low-pass filter 73 is provided, for example, to obtain the opening difference separation characteristics.

The first optical low-pass filter 71 has, for example, the output separation characteristics of performing two-point separation at a separation width “p”, “2 p”, “3 p”, “4 p”, or “5 p”. The third optical low-pass filter 73 has, for example, the opening difference separation characteristics of performing two-point, three-point, four-point, or five-point separation at the separation width p.

The third optical low-pass filter 73 comprises a pair of filters 73A each having characteristics of performing two-point, three-point, four-point, or five-point separation on the point image at the separation width 0.5 p, and a variable wavelength plate 73C provided between the pair of filters 73A.

The variable wavelength plate 73C can switch the wavelength between 0 and λ/2 by electrical control such as voltage control. In a case where the wavelength of the variable wavelength plate 73C is controlled to 0, the third optical low-pass filter 73 has characteristics of performing two-point, three-point, four-point, or five-point separation on the point image at the separation width p.

In a case where the wavelength of the variable wavelength plate 73C is controlled to λ/2, the third optical low-pass filter 73 has characteristics of performing two-point, three-point, four-point, or five-point separation on the point image at the separation width 0, that is, characteristics of not performing separation on the point image.

For example, the separation width of the first optical low-pass filter 71 is set to “3 p”, and the number of separations of the filter 73A is set to three points. In this example, in a case where the imaging element 5 is driven by the drive mode in FIG. 6, the wavelength of the variable wavelength plate 73C is controlled to λ/2. As a result, the optical low-pass filter 7 has characteristics of performing two-point separation at a separation width 3 p (=L).

In addition, in a case where the imaging element 5 is driven by the drive mode in FIG. 5, the wavelength of the variable wavelength plate 73C is controlled to 0. As a result, the optical low-pass filter 7 has characteristics of performing two-point separation at a separation width 3 p (=L) and three-point separation at a separation width p.

The change in the separation characteristics due to the change in the disposition of the optical member as shown in FIG. 17 and the change in the separation characteristics due to the electrical control of the optical member as shown in FIG. 18 can also be combined.

As described above, the system controller 11 changes the characteristics (at least one of n or L described above) of the optical low-pass filter 7 based on the drive mode of the imaging element 5. As a result, it is possible to suppress the false resolution in any drive mode.

It is preferable that, in a case where the drive mode of the imaging element 5 is switched from the first mode to the second mode, the system controller 11 changes at least one of n or L from a value set in the first mode to a value corresponding to the second mode before the imaging for recording is performed by the imaging element 5 after the driving of the imaging element 5 in the second mode is started.

Next, a configuration of a smartphone which is another embodiment of the imaging apparatus according to the present invention will be described.

FIG. 19 is a diagram showing an exterior of a smartphone 200. The smartphone 200 shown in FIG. 19 includes a housing 201 having a flat plate shape and comprises a display and input unit 204 in which a display panel 202 as a display unit and an operation panel 203 as an input unit are integrated on one surface of the housing 201.

In addition, the housing 201 comprises a speaker 205, a microphone 206, an operation unit 207, and a camera unit 208. The configuration of the housing 201 is not limited thereto and, for example, a configuration in which the display unit and the input unit are independently disposed can be employed, or a configuration having a folded structure or a sliding mechanism can be employed.

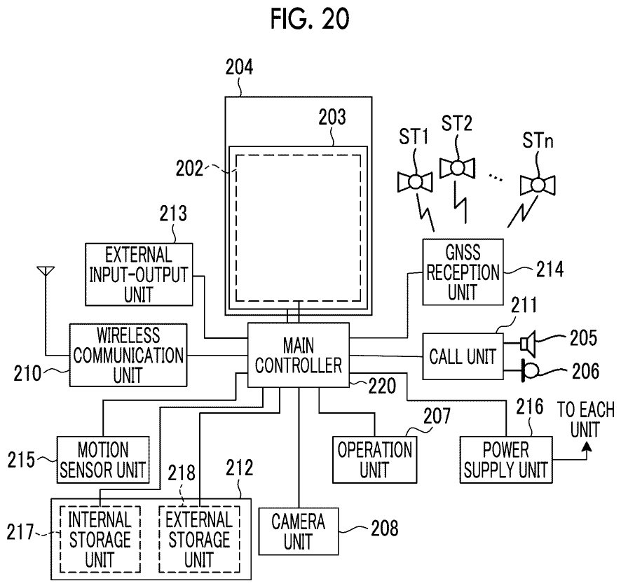

FIG. 20 is a block diagram showing a configuration of the smartphone 200 shown in FIG. 19.

As shown in FIG. 20, the smartphone comprises, as main constituents, a wireless communication unit 210, the display and input unit 204, a call unit 211, the operation unit 207, the camera unit 208, a storage unit 212, an external input-output unit 213, a global navigation satellite system (GNSS) reception unit 214, a motion sensor unit 215, a power supply unit 216, and a main controller 220.

In addition, the smartphone 200 comprises, as a main function, a wireless communication function of performing mobile wireless communication via a base station apparatus BS (not shown) and a mobile communication network NW (not shown).

The wireless communication unit 210 performs wireless communication with the base station apparatus BS accommodated in the mobile communication network NW in accordance with instructions from the main controller 220. By using the wireless communication, transmission and reception of various file data such as audio data and image data, electronic mail data, or the like and reception of web data, streaming data, or the like are performed.

The display and input unit 204 is a so-called touch panel that visually delivers information to the user by displaying images (still images and video images), text information, or the like and that detects a user operation with respect to the displayed information under control of the main controller 220. The display and input unit 204 comprises the display panel 202 and the operation panel 203.

The display panel 202 uses a liquid crystal display (LCD), an organic electro-luminescence display (OELD), or the like as a display device.

The operation panel 203 is a device that is placed such that an image displayed on a display surface of the display panel 202 can be visually recognized, and that detects one or a plurality of coordinates operated with a finger of the user or with a stylus. In a case where the device is operated with the finger of the user or with the stylus, a detection signal generated by the operation is output to the main controller 220. Next, the main controller 220 detects an operation position (coordinates) on the display panel 202 based on the received detection signal.

As shown in FIG. 20, although the display panel 202 and the operation panel 203 of the smartphone 200 shown as an embodiment of the imaging apparatus according to the present invention are integrated to constitute the display and input unit 204, the operation panel 203 is disposed to completely cover the display panel 202.

In a case where such disposition is employed, the operation panel 203 may comprise a function of detecting the user operation even in a region outside the display panel 202. In other words, the operation panel 203 may comprise a detection region (hereinafter, referred to as a display region) for an overlapping portion overlapping with the display panel 202 and a detection region (hereinafter, referred to as a non-display region) for an outer edge portion, other than the overlapping portion, that does not overlap with the display panel 202.

A size of the display region and a size of the display panel 202 may completely match, but both sizes do not need to match. In addition, the operation panel 203 may comprise two sensitive regions of the outer edge portion and an inner portion other than the outer edge portion. Furthermore, a width of the outer edge portion is appropriately designed depending on a size and the like of the housing 201.

Furthermore, examples of a position detection method employed in the operation panel 203 include a matrix switch method, a resistive membrane system, a surface acoustic wave method, an infrared method, an electromagnetic induction method, and a capacitance method, and any method can be employed.

The call unit 211 comprises the speaker 205 or the microphone 206, and converts voice of the user input through the microphone 206 into audio data processable in the main controller 220 and outputs the audio data to the main controller 220, or decodes audio data received by the wireless communication unit 210 or by the external input-output unit 213 and outputs the decoded audio data from the speaker 205.

In addition, as shown in FIG. 19, for example, the speaker 205 can be mounted on the same surface as a surface on which the display and input unit 204 is provided, and the microphone 206 can be mounted on a side surface of the housing 201.

The operation unit 207 is a hardware key that uses a key switch or the like, and receives instructions from the user. For example, as shown in FIG. 19, the operation unit 207 is a push button-type switch that is mounted on the side surface of the housing 201 of the smartphone 200, and is turned on by being pressed with the finger or the like and is set to an OFF state by a restoring force of a spring or the like in a case where the finger is released.

The storage unit 212 stores a control program and control data of the main controller 220, application software, address data in which a name, a telephone number, or the like of a communication counterpart is associated, transmitted and received electronic mail data, web data downloaded by web browsing, and downloaded contents data, and temporarily stores streaming data or the like. In addition, the storage unit 212 is configured with an internal storage unit 217 incorporated in the smartphone and with an external storage unit 218 that has a slot for an attachable and detachable external memory.

Each of the internal storage unit 217 and the external storage unit 218 constituting the storage unit 212 is implemented using a storage medium such as a memory (for example, a MicroSD (registered trademark) memory) of a flash memory type, a hard disk type, a multimedia card micro type, or a card type, a random access memory (RAM), or a read only memory (ROM).

The external input-output unit 213 serves as an interface with all external apparatuses connected to the smartphone 200 and is directly or indirectly connected to other external apparatuses by communication or the like (for example, a universal serial bus (USB), IEEE1394, Bluetooth (registered trademark), radio frequency identification (RFID), infrared communication (Infrared Data Association (IrDA) (registered trademark)), Ultra Wideband (UWB) (registered trademark), or ZigBee (registered trademark)) or through a network (for example, Ethernet (registered trademark) or a wireless local area network (LAN)).

For example, the external apparatuses connected to the smartphone 200 include a wired/wireless headset, a wired/wireless external charger, a wired/wireless data port, a memory card and a subscriber identity module (SIM)/user identity module (UIM) card connected via a card socket, an external audio and video apparatus connected via an audio and video input/output (I/O) terminal, an external audio and video apparatus connected in a wireless manner, a smartphone connected in a wired/wireless manner, a personal computer connected in a wired/wireless manner, and an earphone connected in a wired/wireless manner.

The external input-output unit 213 can deliver data transferred from the external apparatuses to each constituent in the smartphone 200 or transfer data in the smartphone 200 to the external apparatuses.

The GNSS reception unit 214 receives GNSS signals transmitted from GNSS satellites STI to STn, executes positioning computation processing based on the received plurality of GNSS signals, and detects a position consisting of a latitude, a longitude, and an altitude of the smartphone 200 in accordance with instructions from the main controller 220. In a case where positional information can be acquired from the wireless communication unit 210 or from the external input-output unit 213 (for example, a wireless LAN), the GNSS reception unit 214 can detect the position using the positional information.

The motion sensor unit 215 comprises, for example, a three-axis acceleration sensor and detects a physical motion of the smartphone 200 in accordance with instructions from the main controller 220. By detecting the physical motion of the smartphone 200, a movement direction or acceleration of the smartphone 200 is detected. The detection result is output to the main controller 220.

The power supply unit 216 supplies power stored in a battery (not shown) to each unit of the smartphone 200 in accordance with instructions from the main controller 220.

The main controller 220 comprises a microprocessor, operates in accordance with the control program and with the control data stored in the storage unit 212, and manages and controls each unit of the smartphone 200. The microprocessor of the main controller 220 has the same function as the system controller 11. In addition, the main controller 220 comprises a mobile communication control function of controlling each unit of a communication system and an application processing function in order to perform voice communication or data communication through the wireless communication unit 210.

The application processing function is implemented by operating the main controller 220 in accordance with the application software stored in the storage unit 212. For example, the application processing function is an infrared communication function of performing data communication with counter equipment by controlling the external input-output unit 213, an electronic mail function of transmitting and receiving electronic mails, or a web browsing function of viewing a web page.

In addition, the main controller 220 comprises an image processing function such as displaying an image on the display and input unit 204 based on image data (data of a still image or of a video image) such as reception data or downloaded streaming data.

The image processing function refers to a function of causing the main controller 220 to decode the image data, perform image processing on the decoding result, and display the image on the display and input unit 204.

Furthermore, the main controller 220 executes a display control of the display panel 202 and an operation detection control of detecting user operations performed through the operation unit 207 and through the operation panel 203.

By executing the display control, the main controller 220 displays an icon for starting the application software or a software key such as a scroll bar or displays a window for creating an electronic mail.

The scroll bar refers to a software key for receiving an instruction to move a display portion of an image, such as a large image that does not fit in the display region of the display panel 202.

In addition, by executing the operation detection control, the main controller 220 detects the user operation performed through the operation unit 207, receives an operation with respect to the icon and an input of a text string in an input field of the window through the operation panel 203, or receives a request for scrolling the display image made through the scroll bar.

Furthermore, by executing the operation detection control, the main controller 220 comprises a touch panel control function of determining whether the operation position on the operation panel 203 is in the overlapping portion (display region) overlapping with the display panel 202 or is in the outer edge portion (non-display region), other than the overlapping portion, not overlapping with the display panel 202 and of controlling the sensitive region of the operation panel 203 or a display position of the software key.

In addition, the main controller 220 can detect a gesture operation with respect to the operation panel 203 and execute a function set in advance in accordance with the detected gesture operation.

The gesture operation is not a simple touch operation in the related art and means an operation of drawing a path with the finger or the like, designating a plurality of positions at the same time, or as a combination thereof, drawing a path from at least one of the plurality of positions.

The camera unit 208 includes the lens device 40, the optical low-pass filter 7, the imaging element 5, and the digital signal processing unit 17 shown in FIG. 1.

Captured image data generated by the camera unit 208 can be stored in the storage unit 212 or output through the external input-output unit 213 or through the wireless communication unit 210.

In the smartphone 200 shown in FIG. 20, the camera unit 208 is mounted on the same surface as the display and input unit 204. However, a mount position of the camera unit 208 is not limited thereto. The camera unit 208 may be mounted on a rear surface of the display and input unit 204.

In addition, the camera unit 208 can be used for various functions of the smartphone 200. For example, an image acquired by the camera unit 208 can be displayed on the display panel 202, or the image of the camera unit 208 can be used as one of operation inputs of the operation panel 203.

In addition, in a case where the GNSS reception unit 214 detects the position, the position can be detected by referring to the image from the camera unit 208. Furthermore, by referring to the image from the camera unit 208, it is possible to determine an optical axis direction of the camera unit 208 of the smartphone 200 or to determine the current use environment without using the three-axis acceleration sensor or by using the three-axis acceleration sensor in combination. Of course, the image from the camera unit 208 can also be used in the application software.

In addition, image data of a still image or of a video image to which the positional information acquired by the GNSS reception unit 214, voice information (may be text information acquired by performing voice to text conversion via the main controller or the like) acquired by the microphone 206, posture information acquired by the motion sensor unit 215, or the like is added can be stored in the storage unit 212 or be output through the external input-output unit 213 or through the wireless communication unit 210.

### EXPLANATION OF REFERENCES

1: imaging lens
2: stop
4: lens controller
5: imaging element
7: optical low-pass filter
8: lens drive unit
9: stop drive unit
11: system controller
14, 207: operation unit
15: memory controller
16: memory
17: digital signal processing unit
20: external memory controller
21: storage medium
22: display device
22a: display controller
22b: display surface
24: control bus
25: data bus
40: lens device
60: imaging surface
61, 61B, 61G, 61R: pixel
62: pixel row
63: drive circuit
64: signal processing circuit
71: first optical low-pass filter
72: second optical low-pass filter
73: third optical low-pass filter
73A: filter
73C: variable wavelength plate
100: digital camera
100A: body part
200: smartphone
201: housing
202: display panel
203: operation panel
204: display and input unit
205: speaker
206: microphone
208: camera unit
210: wireless communication unit
211: call unit
212: storage unit
213: external input-output unit
214: GNSS reception unit
215: motion sensor unit
216: power supply unit
217: internal storage unit
218: external storage unit
220: main controller
GR1: first group
GR2: second group
P1: first spatial position
P2: second spatial position

What is claimed is:

1. An optical filter disposed on a subject side from an imaging element,
wherein the imaging element is capable of performing at least one of averaging readout of averaging and reading out signals of a plurality of pixels arranged in a first direction or thinning-out readout of reading out the signals from a part of the plurality of pixels arranged in the first direction and not reading out the signals from parts other than the part of the plurality of pixels,
an arrangement pitch of the pixels in the first direction is denoted by p,
a distance between spatial positions of the signals in the first direction read out from the pixels arranged in the first direction is denoted by L,
the number of pixels in which the signals are not read out between a pixel that is a generation source of a signal at a first spatial position and a pixel that is a generation source of a signal at a second spatial position adjacent to the first spatial position is denoted by j,
an absolute value of a difference between the number of pixels that are the generation sources of the signals at the first spatial position and the number of pixels that are the generation sources of the signals at the second spatial position is denoted by k,
a sum of j and k is denoted by n, and
in a case where at least one of the averaging readout or the thinning-out readout is performed, the optical filter has a characteristic in which a point image is separated into (n+1) points with p as a separation width and is separated into two points with L as a separation width, or a characteristic in which a numerical value greater than 0.7 and smaller than 1 is denoted by a, and the point image is separated into (n+1) points with α×p as a separation width and is separated into two points with α×L as a separation width.

2. The optical filter according to claim 1,
wherein, in a case where the averaging readout and the thinning-out readout are not performed, the optical filter has a characteristic in which the point image is separated into two points with L as the separation width.

3. The optical filter according to claim 1,
wherein, in a case where the thinning-out readout is performed among the averaging readout and the thinning-out readout, k=0 is satisfied.

4. The optical filter according to claim 1,
wherein A is set to a natural number of 2 or more,
the averaging readout includes a first averaging readout of reading out a signal at the first spatial position by averaging the signals in A pixels and reading out a signal at the second spatial position from a single pixel,
in the thinning-out readout, at least the signals are not read out from the pixels disposed between the A pixels, and
in a case where both the first averaging readout and the thinning-out readout are performed, k is 1 or more.

5. The optical filter according to claim 1,
wherein A is set to a natural number of 2 or more and B is set to a value larger than A,
the averaging readout includes a second averaging readout of reading out a signal at the first spatial position by averaging the signal in B pixels and reading out a signal at the second spatial position by averaging the signals in A pixels,
in the thinning-out readout, at least the signals are not read out from the pixels disposed between the A pixels and the pixels disposed between the B pixels, and
in a case where both the second averaging readout and the thinning-out readout are performed, k is 1 or more.

6. The optical filter according to claim 1,
wherein A is set to a natural number of 2 or more,
the averaging readout includes a third averaging readout of reading out a signal at the first spatial position by averaging the signals in A pixels and reading out a signal at the second spatial position by averaging the signals in the A pixels,
in the thinning-out readout, at least the signals are not read out from the pixels disposed between the A pixels, and
in a case where both the third averaging readout and the thinning-out readout are performed, k is 0.

7. The optical filter according to claim 1,
wherein at least one of n or L is configured to be changeable.

8. The optical filter according to claim 7,
wherein the optical filter includes a plurality of optical members, and
the characteristic is obtained from a combination of the plurality of optical members.

9. The optical filter according to claim 8,
wherein at least one of n or Lis changed by changing the disposition of the plurality of optical members.

10. The optical filter according to claim 8,
wherein at least one of n or L is changed by an electrical control of any of the plurality of optical members.

11. The optical filter according to claim 2,
wherein at least one of n or L is configured to be changeable.

12. An imaging apparatus comprising:
the optical filter according to claim 1;
the imaging element; and
a processor configured to control the imaging element and the optical filter.

13. The imaging apparatus according to claim 12,
wherein the processor is configured to change at least one of n or L based on a drive mode of the imaging element.

14. The imaging apparatus according to claim 13,
wherein the processor is configured to, in a case where the drive mode of the imaging element is switched from a first mode to a second mode, change at least one of n or L from a value set in the first mode before imaging for recording is performed by the imaging element after driving of the imaging element in the second mode is started.

15. An imaging apparatus comprising:
the optical filter according to claim 1;
the imaging element; and
a processor configured to control the imaging element.

16. An imaging system comprising:
the optical filter according to claim 1;
the imaging element; and
a processor configured to control the imaging element and the optical filter.
